(19) United States
(12) Patent Application Publication
(10) Pub. No.: US 2012/0254134 A1
(43) Pub. Date: Oct. 4, 2012

(54) Using An Update Feed To Capture and Store Documents for Litigation Hold and Legal Discovery

(75) Inventors: Mayank TALATI, Hyderabad (IN); Dan Belov, San Francisco, CA (US); Gopinath Thota, Hyerabad (IN); Shaunak Godbole, Union City, CA (US)

(73) Assignee: Google Inc., Mountain View, CA (US)

(21) Appl. No.: 13/435,191

(22) Filed: Mar. 30, 2012

(30) Foreign Application Priority Data
Mar. 30, 2011 (IN) 1017/CHE/2011

(51) Int. Cl. G06F 17/30

(52) U.S. Cl. 707/695; 707/E17.008; 707/E17.005

(57) ABSTRACT

An electronic discovery archive can continuously pull documents and store them in a way that makes it easy to discover and put documents on litigation hold, independent of the native storage used by a given application. Users can continue to modify documents on litigation hold, and revisions are tracked and saved in the archive to comply with the litigation hold. A legal discovery system can then operate against the archive.

### CROSS-REFERENCE TO RELATED APPLICATIONS

This application claims priority to Indian Provisional Application No. 1017/CHE/2011, filed Mar. 30, 2011, which is incorporated by reference herein in its entirety.

### BACKGROUND

Electronic discovery tools are used in the majority of modern court proceedings to capture and review documents that may be relevant to a particular proceeding. Conventional electronic discovery tools are used to duplicate various devices used in a company, extract potentially relevant information, and load it into a database or other repository for review.

Companies and other business often struggle with the various obligations required by electronic discovery. One particularly difficult obligation is preserving documents for a litigation hold. Litigation hold requires that a user does not delete or modify documents that may be potentially relevant to the litigation, and may be used as evidence. Litigation hold is intended to preserve these documents and allow them to be admissible as evidence before a court.

### BRIEF SUMMARY

In accordance with an aspect of the invention, a method of preserving documents under a litigation hold is described. One or more preservation criterion for a litigation hold is received, and a set of documents distributed across a plurality of client devices that satisfy the preservation criteria is located. A copy of each document satisfying the criteria is stored in a repository. Upon dynamically receiving a notification of an alteration to a particular document in the set of documents, an altered version of the particular document is stored in the repository while maintaining a prior version of the document.

In accordance with another aspect of the invention, notification of a newly created document satisfying the preservation criteria is received. A copy of the newly created document is stored in the repository.

In accordance with another aspect of the invention, an additional preservation criterion is received. Documents corresponding to the additional preservation criterion are located and a repository of documents is updated by storing a copy of each document.

In accordance with another aspect of the invention, a notification is received of a modification of a particular document that upon modification satisfies certain preservation criteria. A copy of the document is stored in the repository.

In accordance with an aspect, exploratory preservation criteria for a litigation hold are received. Documents corresponding to the exploratory preservation criteria are located across a plurality of client devices, and the preservation criteria are finalized based on the exploratory preservation criteria.

In accordance with an aspect, the repository of documents is exported for review.

In accordance with an aspect of the invention, a method of preserving documents under a litigation hold is described. Copies of original documents distributed across a plurality of client devices are stored in a database. Upon receiving notification that an original document has been modified, it is determined whether the original document has been placed on a litigation hold. If the document has been placed on litigation hold, a copy of the modified document is stored in the database along with the original document, such that the original document remains unchanged. If the document has not been placed on litigation hold, a copy of the modified document overwrites the copy of the original document in the database.

In an embodiment, an index of stored copies of altered documents and corresponding original documents is maintained. An original document may be purged upon termination of the litigation hold if an altered document corresponding to the original document exists.

In an embodiment, a notification of a newly created document is received. A copy of the newly created document is stored in the database of documents.

In an embodiment, a notification is received that a document is to be deleted. If the document to be deleted is subject to a litigation hold, the copy of the document in the database is maintained and marked for deletion upon expiration of the litigation hold. If the document to be deleted is not subject to a litigation hold, the document is deleted.

In an embodiment, a notification is received that a new document exists. A copy of the newly created document is stored in the database of documents.

Further embodiments, features, and advantages of the invention, as well as the structure and operation of the various embodiments of the invention are described in detail below with reference to accompanying drawings.

### BRIEF DESCRIPTION OF THE DRAWINGS/FIGURES

Embodiments of the invention are described with reference to the accompanying drawings. In the drawings, like reference numbers may indicate identical or functionally similar elements. The drawing in which an element first appears is generally indicated by the left-most digit in the corresponding reference number.

FIG. 1 is a list of files and associated users used in various examples.

FIG. 2 is a diagram of a traditional computing environment.

FIG. 3 is a diagram of an exemplary hosted user environment.

FIG. 4 is an illustration of an exemplary hosted user environment utilizing a distributed file system.

FIG. 5 is a flow diagram of a method of preserving documents under a litigation hold, according to an embodiment.

FIG. 6A is a diagram of an exemplary hosted user environment with sample documents.

FIG. 6B is a diagram of a hosted user environment with sample documents in accordance with an embodiment.

FIG. 6C is a diagram of a hosted user environment with sample documents in accordance with an embodiment.

FIG. 6D is a diagram of a hosted user environment with sample documents in accordance with an embodiment.

FIG. 6E is a diagram of a hosted user environment with sample documents in accordance with an embodiment.

FIG. 7A is a table representing a database schema in accordance with an embodiment.

FIG. 7B is a table representing a database in accordance with an embodiment.

FIG. 7C is a table representing a database in accordance with an embodiment.

FIG. 7D is a table representing a database in accordance with an embodiment.

FIG. 7E is a table representing a database in accordance with an embodiment.

FIG. 8 is a flow diagram of a method of preserving new documents in accordance with an embodiment.

FIG. 9 is a flow diagram of a method of preserving additional documents in accordance with an embodiment.

FIG. 10 is a flow diagram of a method of preserving modified documents in accordance with an embodiment.

FIG. 11 is a flow diagram of a method of establishing preservation criteria in accordance with an embodiment.

FIG. 12 is an illustration of a method for preserving documents under a litigation hold in accordance with an embodiment.

FIG. 13A is a table representing a database of documents in accordance with an embodiment.

FIG. 13B is a table representing a database of documents in accordance with an embodiment.

FIG. 13C is a table representing a database of documents in accordance with an embodiment.

FIG. 14 is a table representing a list of users on litigation hold in accordance with an embodiment.

FIG. 15 is a table representing a list of documents to delete in accordance with an embodiment.

FIG. 16 is a flow diagram of a method of preserving a newly created document in accordance with an embodiment.

FIG. 17 is an illustration of a litigation hold system in accordance with an embodiment.

### DETAILED DESCRIPTION

In the detailed description of embodiments that follows, references to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Companies subject to litigation threats or those who themselves bring litigations against opposing parties often enforce “litigation holds” on users and data in their computing environments. A litigation hold effectively freezes all data associated with a particular user or other criteria in order to preserve it for the discovery process. Companies who do not impose litigation holds may be subject to sanctions or other punishment imposed by a court.

In many litigations, a designated group of users may be subject to a litigation hold. For example, in a patent infringement litigation case, a group of engineers may be subject to a litigation hold. An in-house or outside attorney may instruct the group of engineers to not modify any documents in their possession or to delete any electronic mail or other documents that may be used as evidence in a litigation or other proceeding. Additionally, users subject to litigation hold must be aware that documents they create while under litigation hold must be preserved as well. Documents created after the litigation hold is imposed may be useful evidence as well.

Imposing this obligation on end users subject to litigation hold may reduce their productivity. Users must be constantly vigilant as to the status of their documents to ensure there are no violations of the litigation hold. Further, in the case of a temporary employee, the temporary employee may not be aware of the litigation hold or may not know to what extent it should be followed.

This manual approach to imposing a litigation hold presents many risks. Litigations in U.S. courts may take many months or years to ultimately conclude. Thus, a user may need to remember for years that he should not delete or modify any documents of which he has control. In order to ensure that the user is vigilant about keeping his documents, he may need frequent reminders from attorneys or other compliance personnel. Further, a given user may be subject to more than one litigation hold if his documents may be relevant to more than one litigation. Relying on the end user to keep track of what documents to keep, and for how long, is ultimately unreliable. Employees also may have collaborated electronically on documents that are not in their possession. A comprehensive litigation hold will seek to keep these documents from further modification as well, but if these documents are not in the employee's possession, this may not be possible.

As more information comes to light and documents are examined in a given litigation, additional employees may be subject to litigation hold. These employees will need to be trained on proper handling of documents during a litigation hold as well. Further, important documents may have been modified or deleted during the gap between the initial litigation hold and the secondary legal hold.

Companies occasionally contract with outside vendors to help manage litigation holds. Conventionally, these outside vendors identify users that should be subject to a litigation hold. In order to preserve documents that may be necessary, the vendor may make a copy of a user's computer hard drive and any other storage media used by the user. The vendor may do this for every user subject to litigation hold.

In order to update the corpus of documents subject to litigation hold, the vendor may need to re-visit the client site and re-clone the hard drive of each user. Additionally, the vendor may identify other users whose data should be cloned to be preserved. The cloning process and updating process may be very time consuming, costly, and require manual intervention.

Electronic documents, along with data comprising the content of the document, usually contain metadata as well. Metadata is generally known as data about data. That is, metadata describes features of the electronic document. For example, metadata for a given document may include the date and time of the document's creation or modification, the author of the document, the names of collaborators of the document, and the size of the document.

Metadata may also include other notes about a document. For example, a user may label a document's metadata with specific text to indicate the document is relevant to a particular subject. Alternatively, a user may label a document's metadata with a notification that it is confidential.

The traditional model of business computing involves individual user machines connected to a network. Also connected to the network are various servers controlling functions such as electronic mail and authentication. In this model, documents generated by individual users are primarily stored on their individual devices, such as desktop computers, laptop computers, tablet devices, or mobile phones.

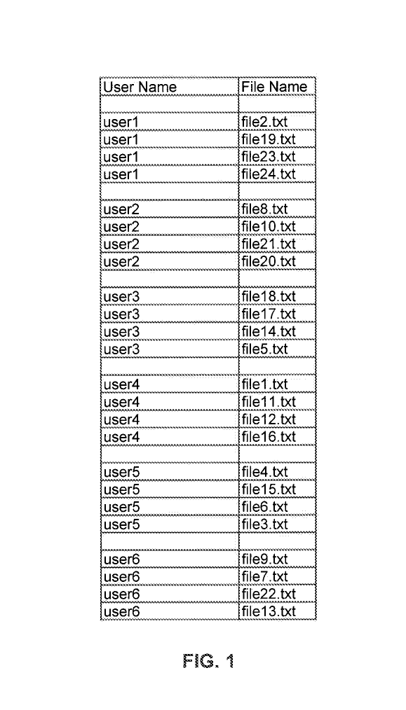

The following explanations of various systems use the table of FIG. 1 as an exemplary reference point. FIG. 1 displays an exemplary list of 24 files, file1.txt through file24.txt, and 6 users, user1 through user6. Each user in this example has four files associated with it.

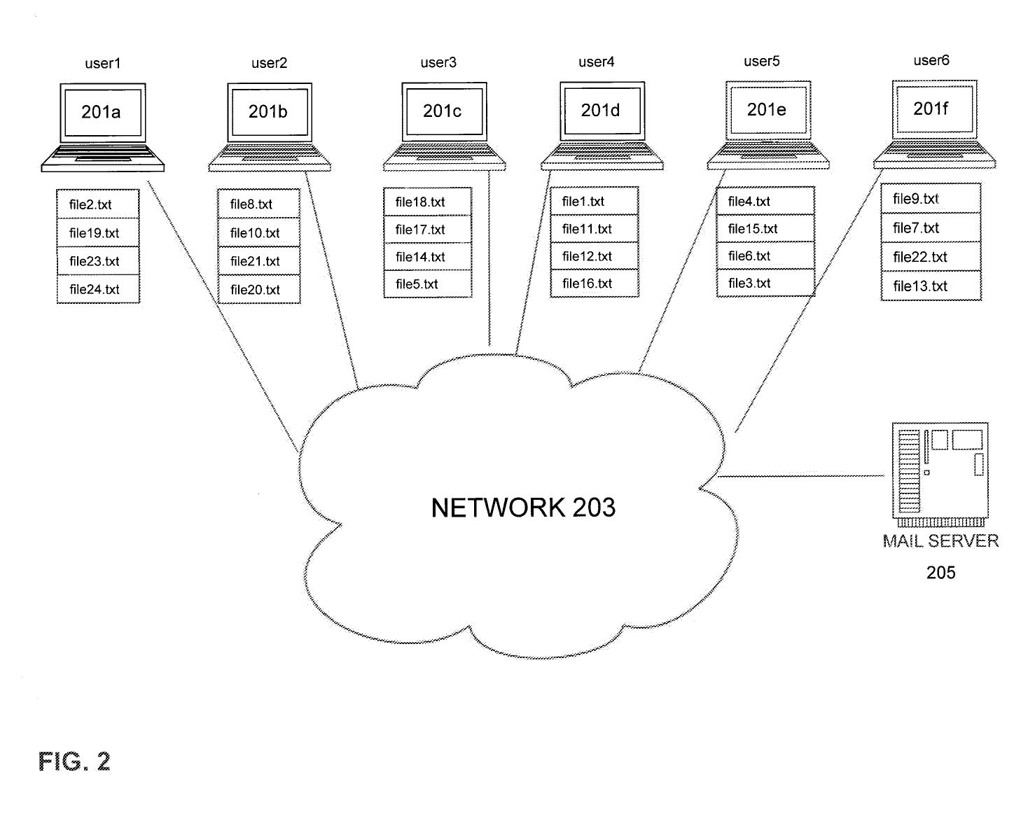

For example, as shown in FIG. 2, user machines 201a through 201f each store four files. Each user machine 201a through 201f may be connected to a network 203, which in turn may connect user machines 201a through 201f to various other machines, such as a mail server 205.

In such a system, the individual user device is a single point of failure. If the device fails for any reason, the data created by the user may be forever inaccessible. For example, if user machine 201a is a portable machine that is lost or destroyed, the files file2.txt, file19.txt, file23.txt and file24.txt may be unrecoverable. This may present legal and other compliance implications, along with an interruption in business.

In the traditional computing environment, conventionally, an electronic discovery vendor hired by a business or law firm tasked to collect and review documents will first create a copy of all data or a subset of data stored on user devices onto a storage device. The vendor may create a complete clone of the user device, or the vendor may extract only particular types of documents. Additionally, the vendor may create a copy of data stored on various servers used by a business, such as a mail server or web server. This process is often labor intensive and time consuming, since the vendor may have to duplicate data stored on many servers, computers, mobile devices, and other electronic communication devices.

In the example of FIG. 2, an electronic discovery vendor may clone or duplicate the storage of user devices 201a through 201f. If user2, for example, creates a new relevant document after the initial collection, the device's storage may have to be re-duplicated to capture the additional document(s). Additionally, if the initial duplication of data focused on electronic mail and text documents, a revised search seeking to include audio data as well may require the vendor or other party to copy data from individual user devices again, this time searching for and copying audio data.

During the collection process, electronic documents such as text files and e-mails may be captured from their native format and converted into image form, such as PDF or TIFF, for future review without a native file viewer. Often, these images are accompanied with the raw text of the native file to be used while searching. One consequence of converting native files into images and raw text is that a relatively small text document may increase in file size once it is converted into an image form. Also, the raw text may lose formatting that may have been present in the original document.

Once the data is copied from user devices, the electronic discovery vendor may load or copy the collected data (images and raw text) into a database for further analysis. Analysis may include filtering out unnecessary documents, marking or tagging particular documents that may be useful, or sending particular documents for further review. Documents are often marked, filtered, or tagged in bulk by way of a query. A vendor may create a query in SQL or other similar database language, and filter or tag a number of documents matching particular criteria.

In a hosted user environment, an individual user device does not store a user's data. Instead, one or more servers store user created data. The advantage of the hosted user environment is that individual user device failure does not affect the status of any data that user or any other user created.

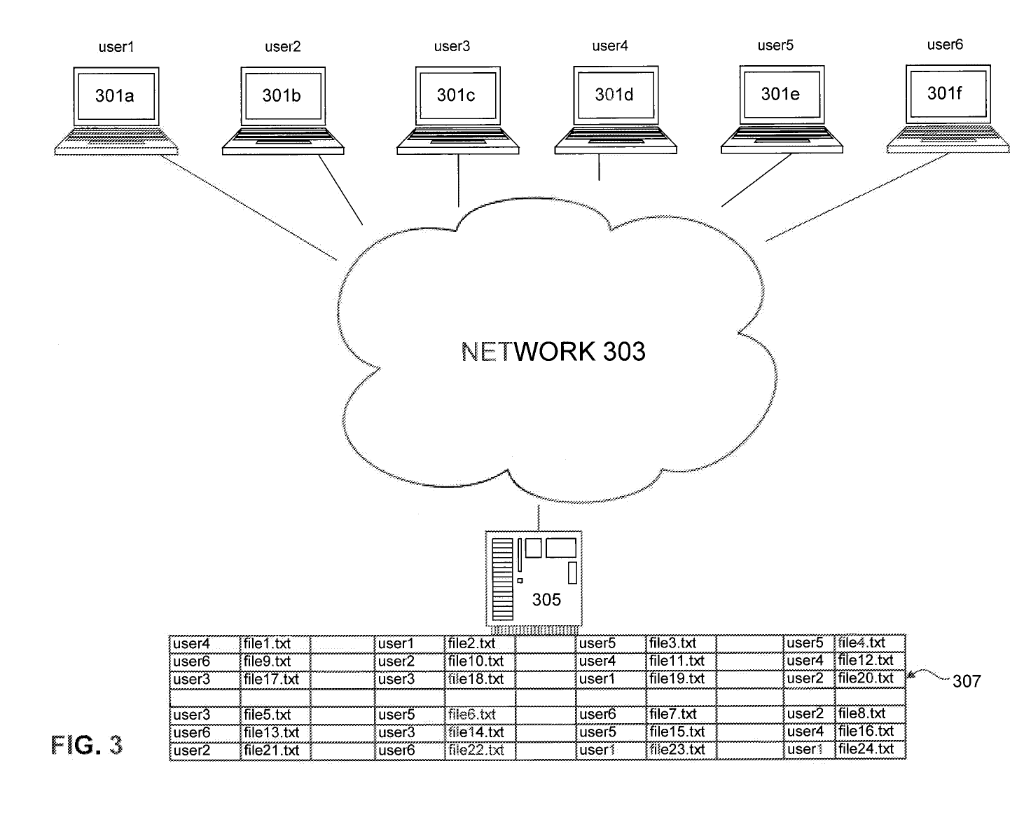

An example of a hosted user environment is shown in FIG. 3. In FIG. 3, user devices 301a-301f are connected to network 303, in a configuration similar to that of FIG. 2. However, in the hosted user environment of FIG. 3, storage server 305 stores file1.txt through file24.txt, and may store an index such as index 307 that details the owner or creator of each file for access control or other purposes. The index may contain more detail than is shown in FIG. 3. In this way, a failure of an individual user device 301a-301f does not render data inaccessible. Additionally, because the storage server 305 is connected to a network, any device on the network may be able to access the data.

Each of user devices 301a-301f and storage server 305 may be implemented on one or more computing devices. Such a computing device can include, but is not limited to, a personal computer, mobile device such as a mobile telephone, workstation, embedded system, game console, television, or set-top box. Such a computing device may include, but is not limited to, a device having one or more processors and memory for executing and storing instructions. Such a computing device may include software, firmware, hardware, or a combination thereof. Software may include one or more applications and an operating system. Hardware may include, but is not limited to, a processor, memory, graphical user interface display, or a combination thereof. A computing device may include multiple processors or multiple shared or separate memory components. For example, a computing device may include a cluster computing environment or server farm.

Network 303 may be any network or combination of networks that can carry data communication. Such a network 303 may include, but is not limited to, a local area network, medium area network, and/or wide area network such as the Internet. Network 108 can support protocols and technology including, but not limited to, World Wide Web protocols and/or services. Intermediate web servers, gateways, or other servers may be provided between components of the system shown in FIG. 3 depending upon a particular application or environment.

If storage server 305 suffers a performance reduction, user1 through user6 may be affected. Additionally, if storage server 305 fails for any reason, all data may be inaccessible for a period of time. Further, a search of a hosted user environment as in FIG. 3 may take a large amount of time if the amount of data stored on storage server 305 is large. For example, if a given search takes 0.5 seconds per document to execute, a search of 24 documents as in FIG. 3 may take 12 seconds.

Further, electronic discovery in a hosted user environment first involves identifying the server device or server devices used in a company's network. Then, the various storage media of each server, such as hard drives, CD-ROM, tape drives, or other storage media, must be duplicated. The users subject to discovery must be identified, and their documents and other data extracted. In a large company, a hosted user environment storage device may possess a large number of documents and massive storage devices that would take many hours to duplicate.

Later updating the set of documents encounters similar problems. The storage media of the hosted user environment may need to be re-duplicated, and may take as much time as the initial collection of documents.

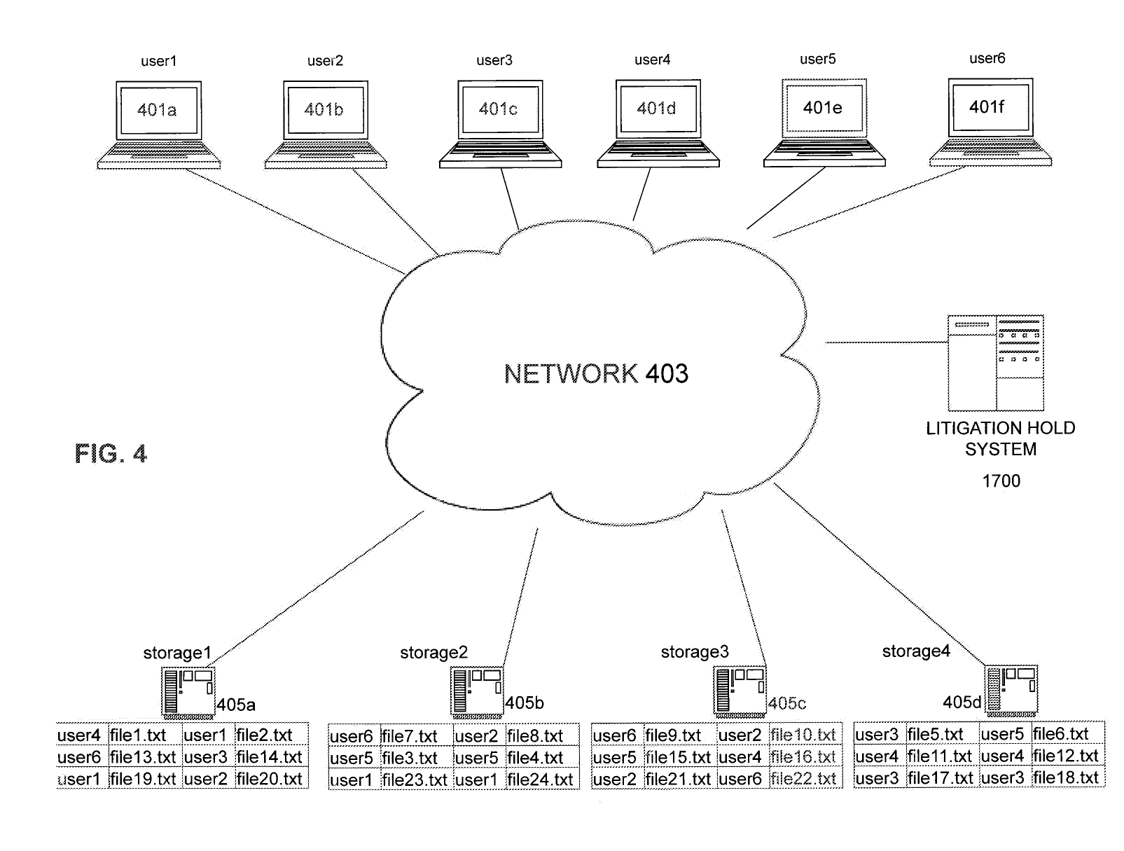

According to an embodiment, an exemplary hosted user environment utilizing a distributed file system is shown in FIG. 4. In FIG. 4, documents are not stored on individual user devices. Instead, documents are spread across a multitude of storage devices 405a-405d. Documents may be distributed equally among the storage devices, as in FIG. 4, or in any other method. Each storage device may have an index of documents stored in it, such as the indices shown in FIG. 4. Each index may contain more data than is shown in FIG. 4. Further, the distributed file system may use a master index to indicate which storage devices 405a-405d hold which files.

Each of user devices 401a-401f and storage devices 405a-405d may be implemented on one or more computing devices. Such a computing device can include, but is not limited to, a personal computer, mobile device such as a mobile telephone, workstation, embedded system, game console, television, or set-top box. Such a computing device may include, but is not limited to, a device having one or more processors and memory for executing and storing instructions. Such a computing device may include software, firmware, hardware, or a combination thereof. Software may include one or more applications and an operating system. Hardware may include, but is not limited to, a processor, memory, graphical user interface display, or a combination thereof. A computing device may include multiple processors or multiple shared or separate memory components. For example, a computing device may include a cluster computing environment or server farm.

Network 403 may be any network or combination of networks that can carry data communication. Such a network 403 may include, but is not limited to, a local area network, medium area network, and/or wide area network such as the Internet. Network 108 can support protocols and technology including, but not limited to, World Wide Web protocols and/or services. Intermediate web servers, gateways, or other servers may be provided between components of the system shown in FIG. 3 depending upon a particular application or environment.

The hosted user environment utilizing a distributed file system shown in FIG. 4 may also include a litigation hold system 1700. Litigation hold system 1700 is further described below in accordance with embodiments described herein.

A hosted user environment utilizing a distributed file system such as the one shown in FIG. 4 has a number of advantages over the traditional computing and hosted user environments. For example, a hardware failure in a distributed file system may only affect a small subset of documents. The vast majority of the documents in the environment may still be accessible. Further, search times may be reduced in a distributed file system. In the example above, a given search may take 0.5 seconds per document to execute. In the example of FIG. 4, where each storage device has six documents to search, each storage server may execute the query in 3 seconds. Even including any overhead in retrieving search results from the six servers, the search query execution time is much faster than that of FIG. 3.

Further, a hosted user environment utilizing a distributed file system is scalable. If a company desires more capacity in its hosted user environment, it can add an additional storage device to decrease how many files are stored on an individual device. In terms of the example of FIG. 4, a company could add a fifth storage device, and each storage device may store fewer files.

In a distributed file system, because documents are not stored on individual user devices, electronic discovery tools may need to be adapted to the specific characteristics of the distributed file system. In the hosted user environment of FIG. 3, user documents and data may be stored on one machine that may be duplicated. In a hosted user environment utilizing a distributed file system such as that of FIG. 4, multiple devices may need to be duplicated, and the relevant files must be extracted from each device. As companies grow in size, this solution may become untenable.

In a hosted user environment utilizing a distributed file system, documents and data are stored across multiple client devices or storage machines. In a traditional electronic discovery model, each storage machine in a hosted user environment would typically be cloned in order to comply with legal requirements. In a large business with many employees, this may entail copying the storage of hundreds of machines.

The client devices may be individual user machines. However, in a hosted user environment, because individual user machines generally do not contain documents or other data created by users, data is stored on a server or servers connected to a network such that any user using any machine may have access to his or her data at any network-accessible machine. In a hosted user environment using a distributed file system, instead of using a small number of servers with large capacities to store data, data is distributed across a large number of machines, where each machine stores fewer documents than a traditional hosted user environment, but in the aggregate, the same amount of documents. In a distributed computing environment, an individual user's data may be spread across a multitude of machines and across a multitude of applications for reliability, quick access, and security.

As described below, embodiments relate to using an update feed mechanism to track and store documents for litigation hold and legal discovery with minimal end-user involvement. In embodiments described herein, a centralized database server connected to a network may query a set of client devices to copy all data or selected data without physically intervening with any particular machine. In order to preserve documents subject to a litigation hold, copies of documents matching preservation criteria are stored into a central archive, such as a database, which supports documents on litigation hold. Documents matching preservation criteria are monitored for updates and deletions. If a document is modified, a copy of the original document is preserved in order to comply with the litigation hold. Additionally, a copy of the modified document is also saved in the central archive. Updated copies of documents may also be stored in the central archive for discovery purposes. Documents deleted by users are maintained in the central archive. Newly created documents matching preservation criteria are also copied into the central archive upon their discovery. In this way, reliance on end users is not necessary to comply with the obligations of the litigation hold. Embodiments described herein may create copies of documents seamlessly without user intervention to preserve the litigation hold.

Synchronization of documents with a central archive may be a low latency operation, which prevents users from unnecessary performance reductions. Embodiments described herein may also not require modification of individual applications utilized in a business. Rather, a litigation hold system operating in accordance with embodiments may perform the necessary functions.

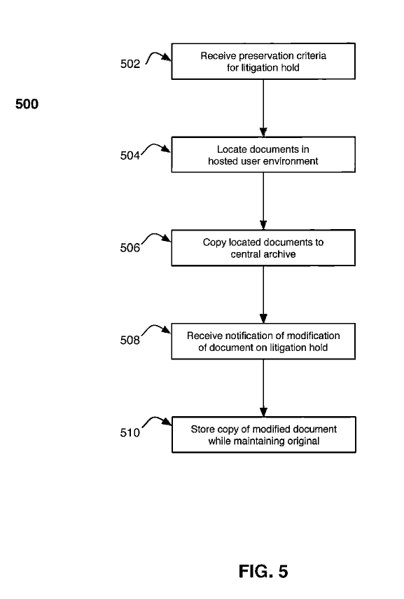

FIG. 5 is an illustration of an exemplary method 500 for preserving documents subject to litigation hold in a hosted user environment for a particular matter, according to an embodiment. Each block of the exemplary method 500 will be further explained below with reference to additional figures. At block 502, preservation criteria for a litigation hold are received. Preservation criteria may identify a certain set of custodians or accounts in a company, a certain type of document, documents all relating to a particular topic, a query, or any other desired preservation criteria. Preservation criteria also may identify one or more keywords to be present in the documents to be placed on litigation hold.

At block 504, the various accounts, devices, client devices, and storage devices present in the hosted user environment may be queried in accordance with the preservation criteria to locate and return documents and other data that match the preservation criteria established in accordance with block 504. For example, if the preservation criteria identifies user account names, documents returned may be those that have been created, modified or viewed by those user account names. Documents satisfying the preservation criteria may also be marked as being on litigation hold, for example and without limitation, by updating an element of metadata to indicate that the document is on litigation hold.

At block 506, a copy of all documents satisfying the preservation criteria are stored into a repository, such as a database. This database may be known as a central archive which supports documents on litigation hold. The central archive may be implemented in hardware, software, firmware, or any combination thereof. Although the central archive is described herein as a single database, it may include multiple databases or storage locations, such as, for example and without limitation, across a distributed file system.

In the course of normal business, a user may modify an existing original document of which a copy is present in the central archive. At block 508, a notification is received that an existing original document has been modified. Such a notification may be triggered in a number of ways. The notification may be triggered by the software being used to modify the document, or by another method known to those skilled in the art. For example, the software being used to modify the document may recognize the element of metadata indicating that the document has been placed on litigation hold. Also, the set of potentially relevant documents present in the hosted user environment may be periodically queried to determine whether documents have been updated. The set of potentially relevant documents may be, for example, all documents used by the various users and devices in a computing environment, excluding system files and other non-content documents. For example, if the last modified time and date of a particular document is after the last query of the set of potentially relevant documents, a notification may be received of a modified document. Additionally, upon opening the document, a notification may be triggered from the word processing software, spreadsheet software, or other software used to create the document. An update feed may contain one or more notifications that an existing original document has been modified.

In response to the notification that a document has been modified, at block 510, the modified document is stored in the central archive. Additionally, the original document is maintained in the central archive to comply with the litigation hold.

In an embodiment, for each document matching preservation criteria, various data may be retrieved and stored in the central archive. For example, metadata for each document may be useful to a legal team, and may be stored in the central archive. Further, each document may be converted from its original format to another format, such as Hypertext Markup Language (HTML) and/or an industry standard format such as Portable Document Format (PDF). In an embodiment, if the conversion fails, the document may be labeled with a conversion failure label, and conversion may be re-attempted at a later point.

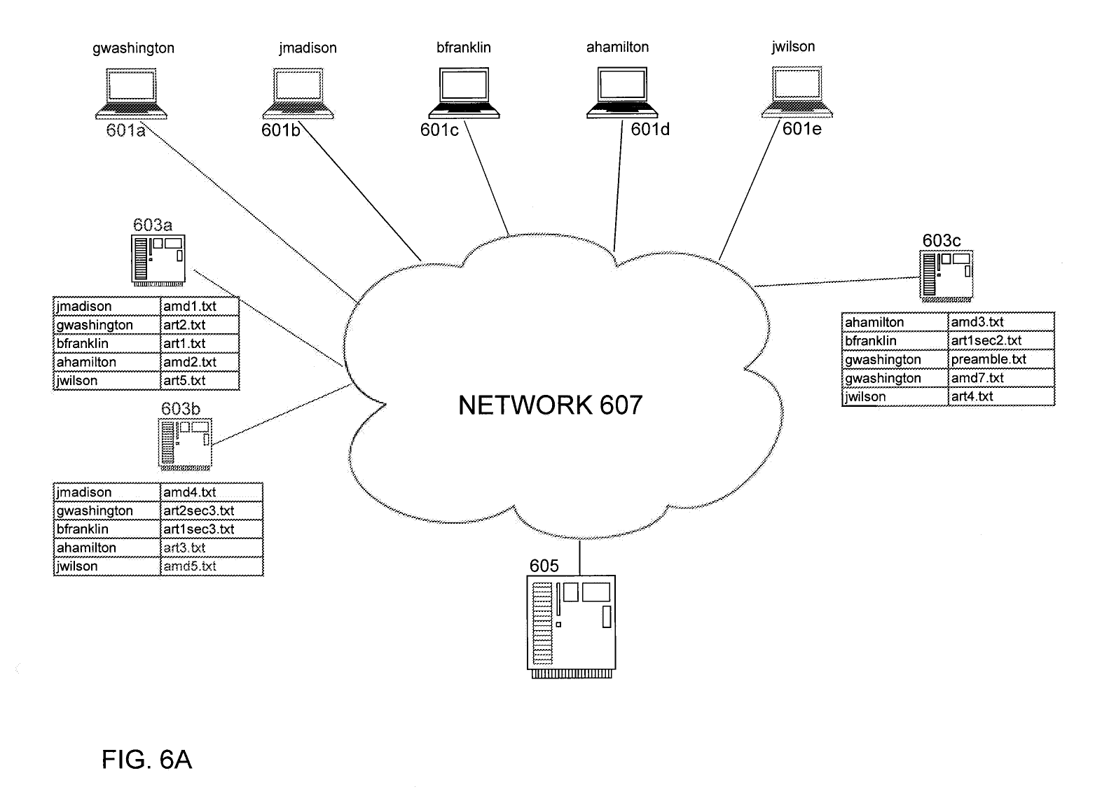

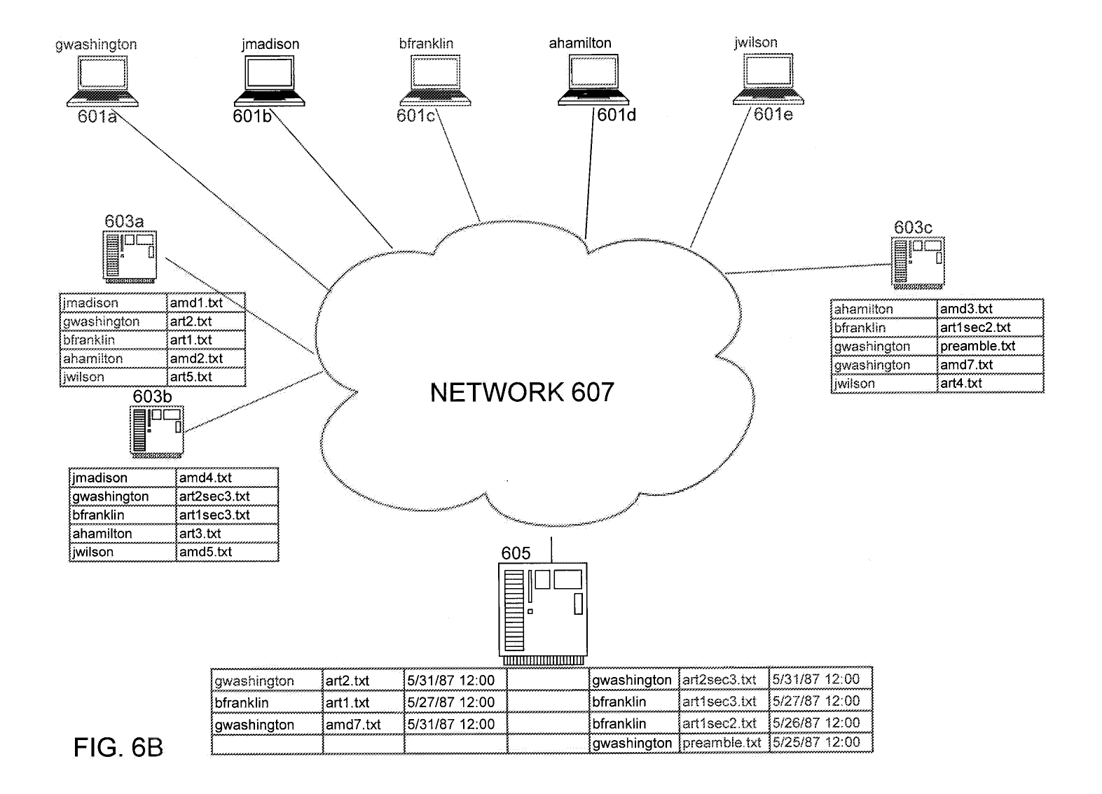

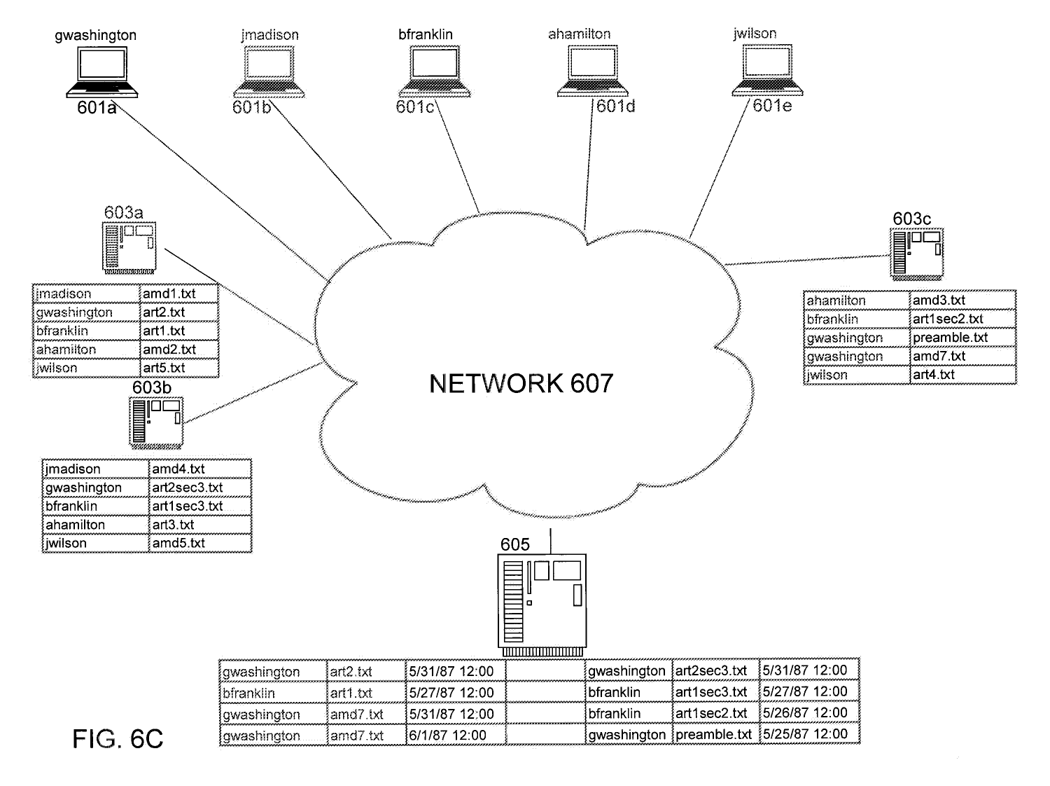

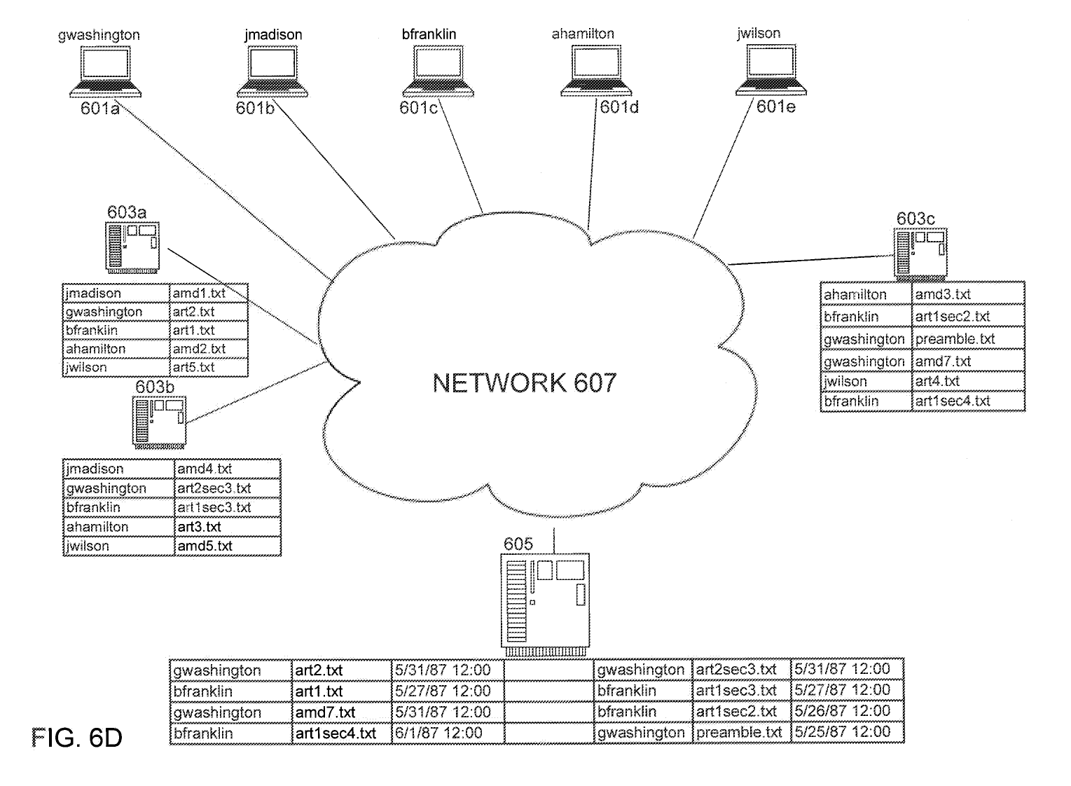

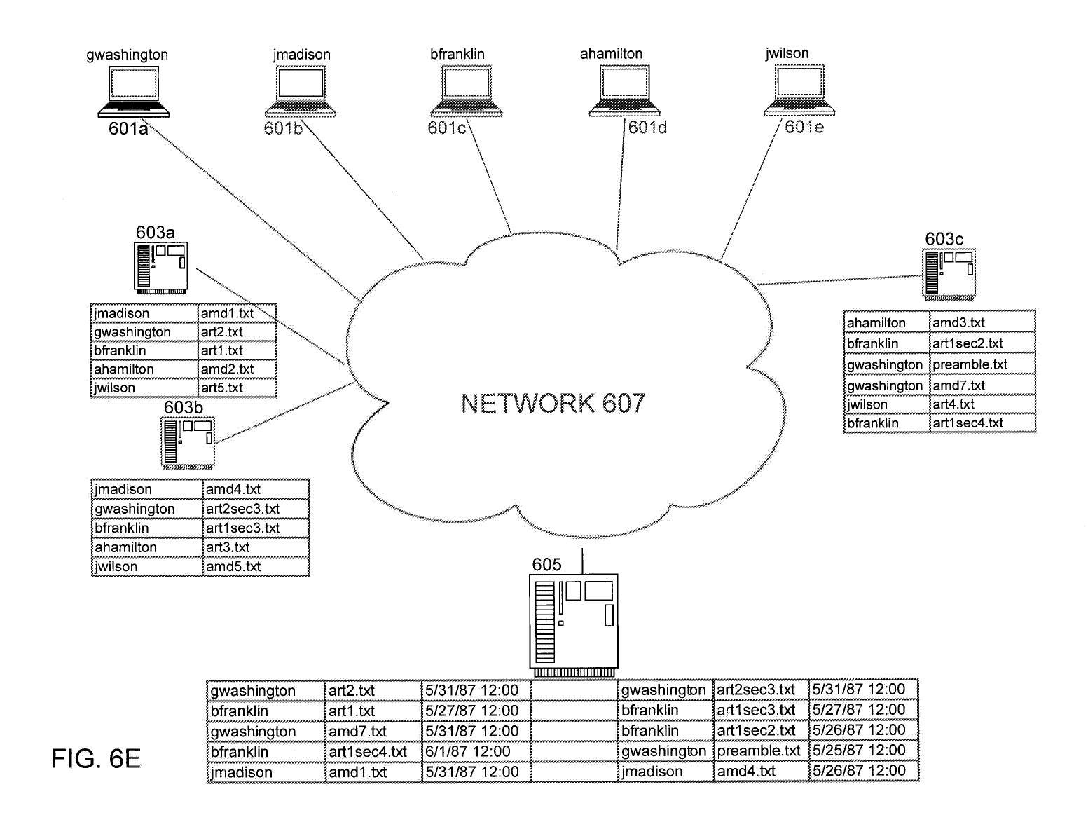

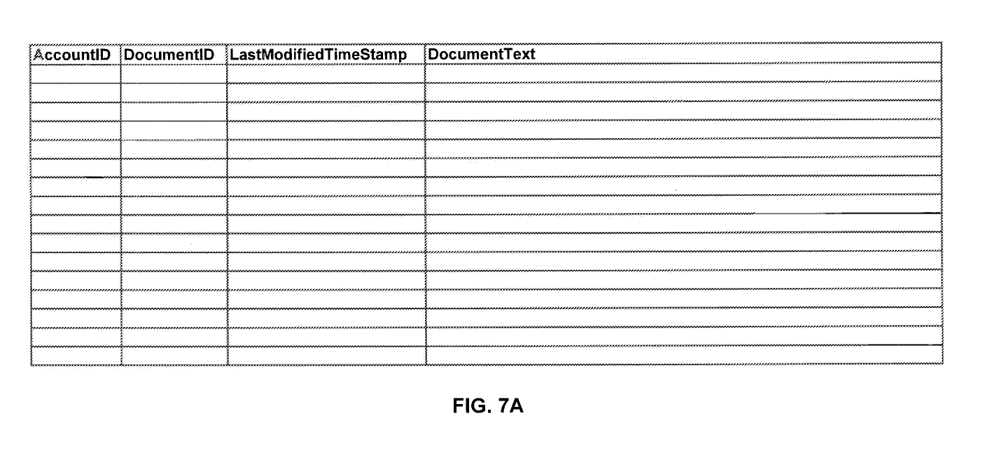

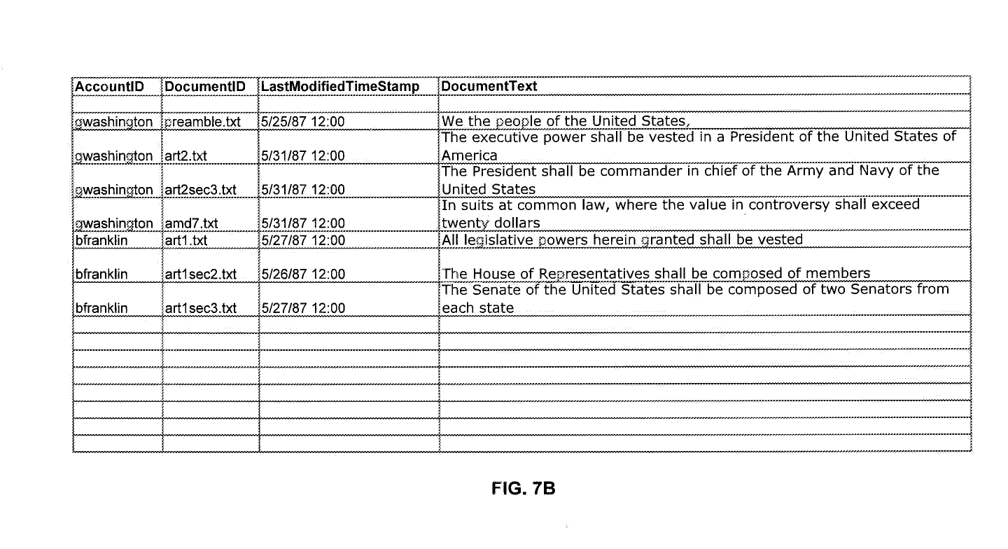

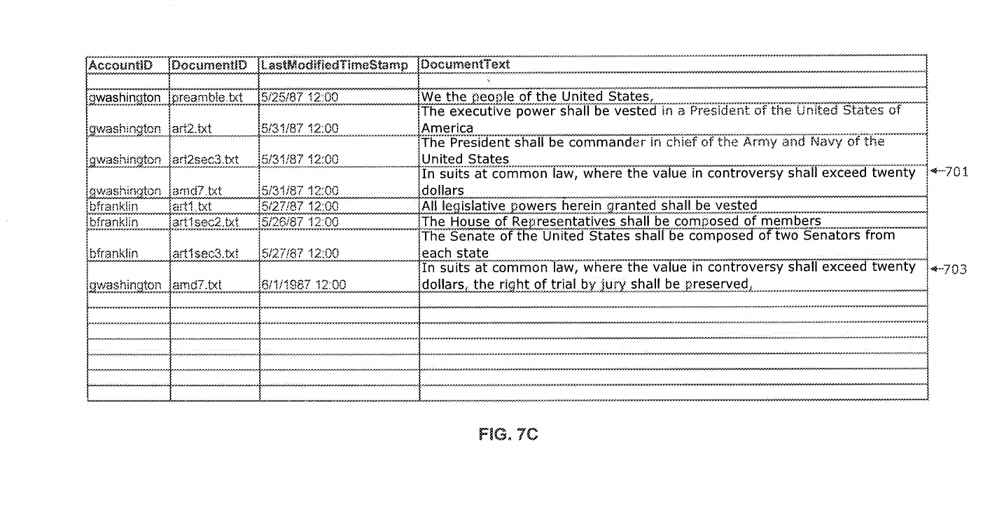

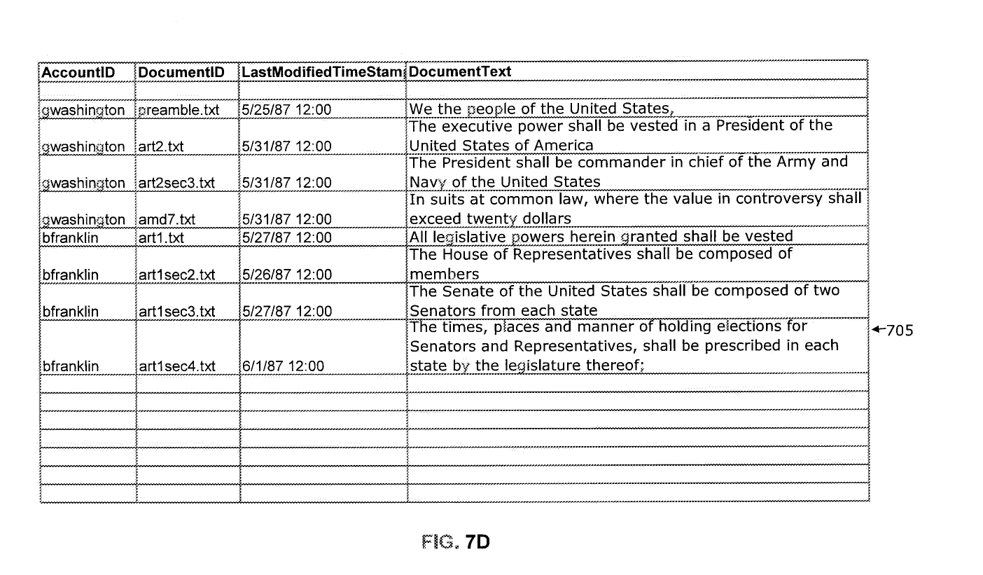

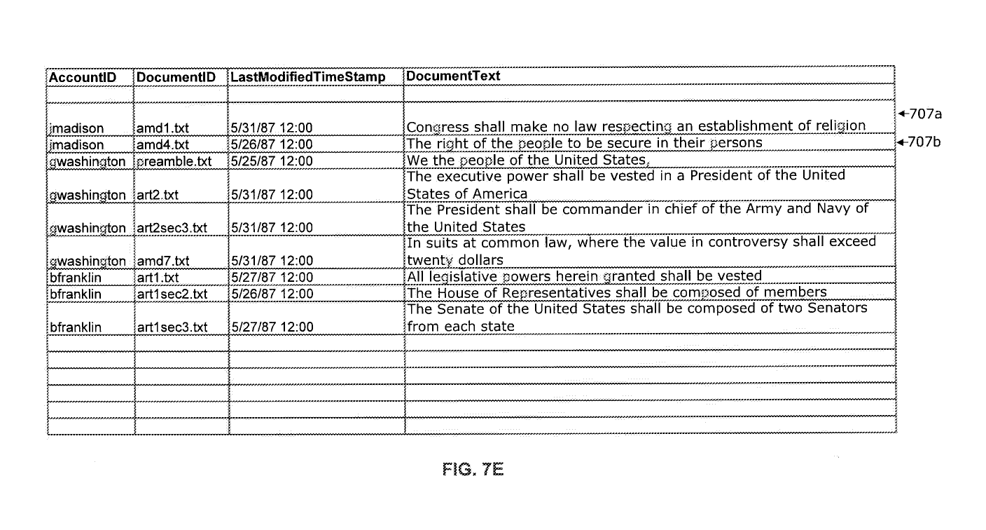

An example of method 500 follows. FIG. 6A is an illustration of an exemplary hosted user environment with five users 601a-601e, three storage devices 603a-603c, and a central archive 605 supporting documents on litigation hold, according to an embodiment. Storage devices 603a-603c each contain five documents created by the users in the hosted user environment. The devices in the hosted user environment are all connected via network 607. Network 607 may be a local area network, medium area network, or a wide area network such as the Internet. FIG. 7A is a sample schema for a central archive supporting documents on litigation hold according to an embodiment, containing the fields AccountID, DocumentID, LastModifiedTimeStamp, and DocumentText.

The AccountID field may contain the username or other identifying text for the creator of the document. In an embodiment, the AccountID field may list user accounts responsible for creating a document, editing or collaborating on a document, and those who have viewed a document. The DocumentID field may include text that identifies the particular document that is stored in the database. For example, the DocumentID field may contain the full or relative path to the document stored in the database. The LastModifiedTimeStamp field may include the date and time that the particular document noted in the DocumentID field was last created, modified, or updated. The DocumentText field may include the full text of the document inserted into the database. The DocumentText field may also include a link or other reference to a separate storage location for the full text of the document.

The schema for the update feed, which tracks modifications and deletions, may vary depending on the specific implementation of embodiments disclosed herein. In an embodiment, the schema may be as shown in TABLE 1, below.

TABLE 1

| | | | | |
|---|---|---|---|---|
| RowKey: | DocumentRequest | ArchiveDocument | Error | BlobRef |
| Marshaled Id | | | | |

For example, the schema may include an ID column, represented by the Marshaled Id column of TABLE 1, which is a unique value that may act as the key for the update feed. Additionally, the schema may include a column named DocumentRequest, which may identify the particular request associated with the document on litigation hold. Further, the schema may include a column named ArchiveDocument, representing a location or other identifying information for a particular document. The schema may include an Error column, which may indicate whether an error occurred during the copying of the particular document or other operation, such as conversion. Finally, the schema may include a column named BlobRef, which may contain the actual data of a particular document.

Preservation criteria may be established in accordance with block 502 of method 500. In this example, two users, gwashington and bfranklin, are placed on litigation hold. As described above, preservation criteria corresponding to a litigation hold may also specify, for example and without limitation, a date range of documents to be placed on litigation hold, or a particular query or keyword to place documents on litigation hold satisfying the particular query or keyword. Preservation criteria are established to place those users' documents on litigation hold. In accordance with block 504, storage devices 603a, 603b and 603c are queried to locate documents associated with user accounts gwashington and bfranklin.

In accordance with block 506 of method 500, a copy of the documents satisfying the preservation criteria are stored in the central archive 605. FIG. 6B is an illustration of the hosted user environment of FIG. 6A after locating and copying documents satisfying the preservation criteria, according to an embodiment. FIG. 7B is a representation of the exemplary contents of central archive 605 after documents satisfying the preservation criteria are stored in the central litigation database.

On Jun. 6, 1787, user gwashington may make a modification to document amd7.txt, and append a line of text to the document. Upon making the modification, an update feed containing a notification is sent to the central archive of such a modification. In accordance with block 510 of method 500, a copy of the modified document is added to the central archive 605. FIG. 6C is a representation of the hosted user environment after user gwashington's modification of document amd7.txt.

FIG. 7C is a representation of the contents of the central archive after a copy of the modified document is added to central archive 605. Original document amd7.txt is still present in the central archive in row 701. Additionally, modified document amd7.txt is stored in the central archive in row 703, and noted by a later date of modification.

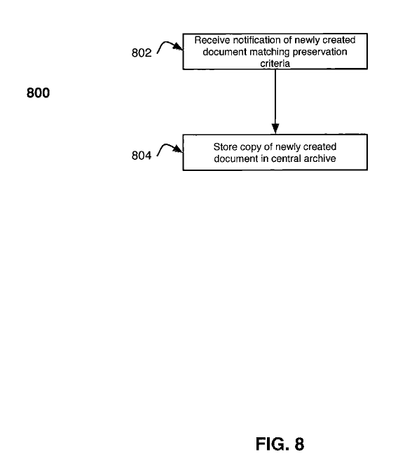

In an embodiment, newly created documents corresponding to a litigation hold may also be stored in the central archive when they are created. FIG. 8 is an illustration of an exemplary method 800 in accordance with this embodiment.

At block 802, a notification of a newly created document corresponding to preservation criteria is received. The notification may be triggered in a number of ways. For example, the software used to create the document may be periodically updated with a list of users on litigation hold. If a user on litigation hold creates a document using word processing software, for example, the software may send a notification to the central archive notifying it of such an event. The notification also may be triggered during a regularly run search or scan of the hosted user environment for documents satisfying the preservation criteria. For example, a search may take place each night to locate new documents that correspond to preservation criteria. The search may send a notification to the central archive if such documents are located. One or more such notifications may be sent as an update feed to the central archive.

At block 804, if the notification is received, a copy of the newly created document is stored in the central archive. The central archive may be updated with the various information about the document, such as the last date it was modified, AccountID, and the text of the document. Additionally, the document's metadata may be updated to indicate that the document is on litigation hold.

Extending the above example with respect to method 800, as shown in FIG. 6D, user bfranklin may create a new document named art1sec4.txt on Jun. 1, 1787. Because the document was created by user bfranklin, a user on litigation hold, a notification may be sent to the central archive as an update feed. The notification may be sent by the word processing software used by user bfranklin, or a periodic search of the hosted user environment may have identified the new document since the most recent search of the hosted user environment. In response to the notification, the central archive stores a copy of user bfranklin's document art1sec4.txt.

FIG. 6D is a representation of the hosted user environment after user bfranklin creates document art1sec4.txt. Accordingly, the central archive is updated to include the document art1sec4.txt, as illustrated by the representation contained in FIG. 7D at row 705.

In an embodiment, an update feed may include notifications of modified documents as well as notifications of newly created documents matching the preservation criteria. For example and without limitation, a search may take place on a nightly basis to determine whether existing documents on litigation hold have been modified since the last search, as well as whether documents created since the last search satisfy preservation criteria. An update feed containing notifications of all documents matching the search may be received by the central archive to indicate that the documents listed in the update feed should be preserved in accordance with embodiments described herein.

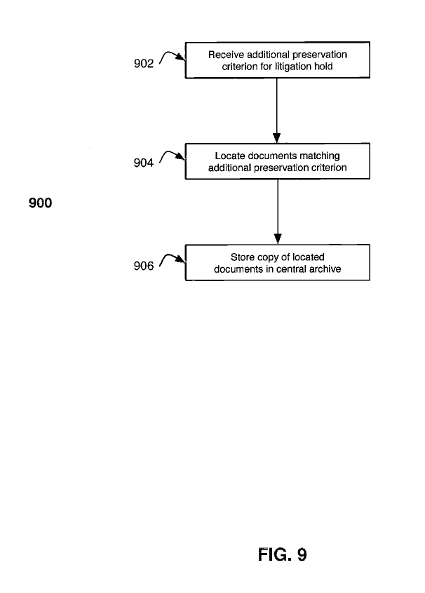

In an embodiment, additional preservation criteria may be specified after an initial search has been run. For example, after an initial collection of documents as detailed with respect to method 500 of FIG. 5, an additional user who should be placed on litigation hold may be identified. Documents created by or collaborated on by this user may need to be placed on litigation hold as well. FIG. 9 is an illustration of an exemplary method 900 in accordance with this embodiment.

At block 902, one or more additional preservation criteria for a litigation hold are received. The additional preservation criteria may include an additional user or users subject to litigation hold, an additional type of document to be placed on litigation hold, or any other additional desired criteria.

At block 904, a set of documents that satisfy the additional preservation criteria are located across a plurality of client devices. As described above, the client devices may be individual user machines, or storage servers in a distributed file system. Documents may be located by comparing the additional preservation criteria with the criteria of each document in the set of potentially relevant documents.

At block 906, a copy of each document in the set of located documents is added to the central archive. The central archive is updated with the applicable information of each located document.

In an example of the above embodiment, user jmadison may be identified as an additional custodian to be placed on litigation hold. Documents created by user jmadison are located in the hosted user environment of FIG. 6A. The located documents are added to the central archive 605, as shown in the example of FIG. 6E. FIG. 7E is a representation of the central archive after user jmadison is identified as an additional custodian to be placed on litigation hold, according to an embodiment. Documents belonging to user jmadison may then be included in the central archive, such as at rows 707a and 707b of FIG. 7E.

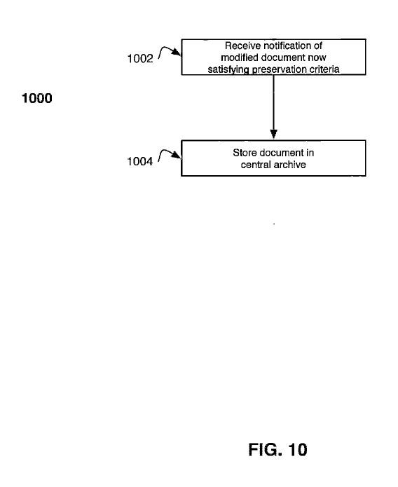

In an embodiment, an existing document that did not satisfy the preservation criteria may be modified. Upon modification, the modified version of the existing document may satisfy the preservation criteria. In order to comply with legal obligations, the document should be added to the central archive to ensure preservation with the litigation hold. FIG. 10 is an illustration of a method 1000 in accordance with an embodiment.

At block 1002, a notification of a modification of a particular document that upon modification satisfies preservation criteria is dynamically received. Such a notification may be triggered in many ways. For example, preservation criteria may specify that all documents with file names starting with a given block of text, such as “art”, should be placed on litigation hold. Upon modifying a file's name to begin with the block of text, a user's file manager software may send a notification of such an event. Alternatively, if a particular user is on litigation hold, adding that user as a collaborator on a document may trigger the software used to create the document to send a notification of such an event. Other identification and notification methods, such as content analysis, will be known to those skilled in the art.

Upon receiving notification in block 1002, the document is stored into the central archive in block 1004. This is to ensure that the document is preserved for purposes of a litigation hold.

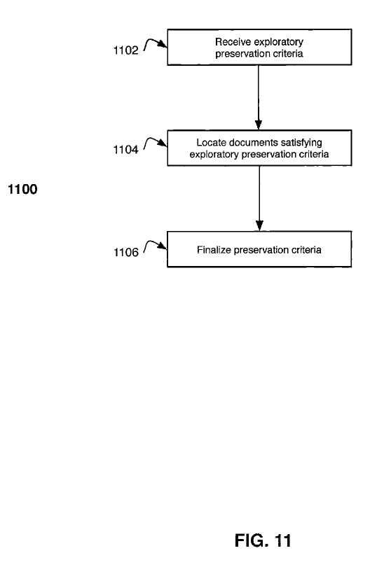

In an embodiment, a user may wish to test preservation criteria before committing further resources to a document review or other analysis. For example, a user may wish to minimize the size of a result set in order to facilitate quick review of the documents that may be found. FIG. 11 is an illustration of an exemplary method 1100 in accordance with this embodiment.

In block 1102, exploratory preservation criteria for a litigation hold is received. The exploratory preservation criteria may specify one or more users to be placed on litigation hold, criteria of documents to be placed on litigation hold, or any other desired criteria.

At block 1104, a set of documents corresponding to the exploratory preservation criteria are located across a plurality of client devices. For example, each client device in a hosted user environment may return a list of documents corresponding to the exploratory preservation criteria. Upon viewing the results of the exploratory preservation criteria, the user may wish to modify the exploratory preservation criteria to return a new list of documents corresponding to the new exploratory preservation criteria until he or she is satisfied with the results.

At block 1106, the preservation criteria are finalized, based on the results of the exploratory preservation criteria. After the preservation criteria are finalized, the criteria may be used in method 500 of FIG. 5 detailed above.

In an embodiment, once a collection set has been created in the central archive, it may be exported into a format that is suitable for review. For example, the collection set may be exported onto a hard drive, CD-ROM, DVD-ROM, tape drive, or other storage media to be provided either to an opposing party or a electronic discovery vendor for review.

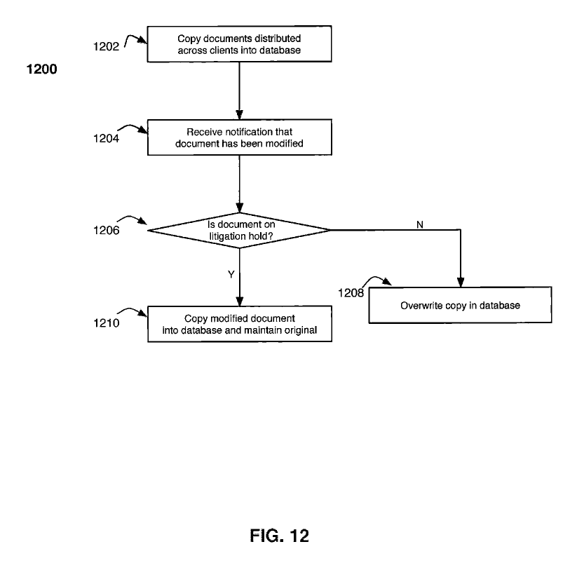

In an embodiment, a set of potentially relevant documents is tracked to preserve documents on litigation hold that may be modified. The set may include all documents, substantive documents, or any other set of documents that fulfill a particular preservation requirement. FIG. 12 is an illustration of method 1200 for preserving documents under a litigation hold in accordance with an embodiment.

In block 1202, a copy of the set of documents distributed across a plurality of client devices is copied into a database or other repository. The documents may be text documents, spreadsheets, presentations, e-mails, or any other type of document used in a company. The repository may be connected directly to the client devices, or connected via a network such as a local area network, medium area network, or wide area network such as the Internet.

In the course of normal business, a user may modify an existing original document. The user or the document being modified may or may not be subject to a litigation hold. At block 1204, a notification is received that an existing original document has been modified. The notification may be triggered by the software being used to modify the document, or by another method known to those skilled in the art. Also, the set of documents may be periodically queried to determine whether documents have been updated. For example, if the last modified time and date of a particular document is after the most recent query of the set of documents, a notification may be received indicating a modified document.

In response to the notification that a document has been modified, in block 1206, it is determined whether the original document was subject to a litigation hold. The determination of whether a document was subject to a litigation hold may take place, for example, by determining whether the user's name or account identification is on a list of users subject to litigation hold. In an embodiment, the determination of whether a document is on litigation hold may be based on criteria inherent to the document itself, such as a type of document or content of the document.

If the document is not subject to a litigation hold, the method proceeds to block 1208. At block 1208, the copy of the original document stored in the database of all documents is overwritten with the altered document. Because the document is not under litigation hold, there may be no need to preserve the original copy. Thus, in order to save capacity on the machine hosting the database, a company may desire to overwrite the original document.

If the document satisfies criteria of documents subject to a litigation hold, the method proceeds to block 1210. At block 1210, the copy of the original document stored in the database is maintained. Further, in order to comply with a continuing duty of disclosure in a litigation hold, a copy of the modified document is also inserted into the database of documents. An example execution of method 1200 is described below.

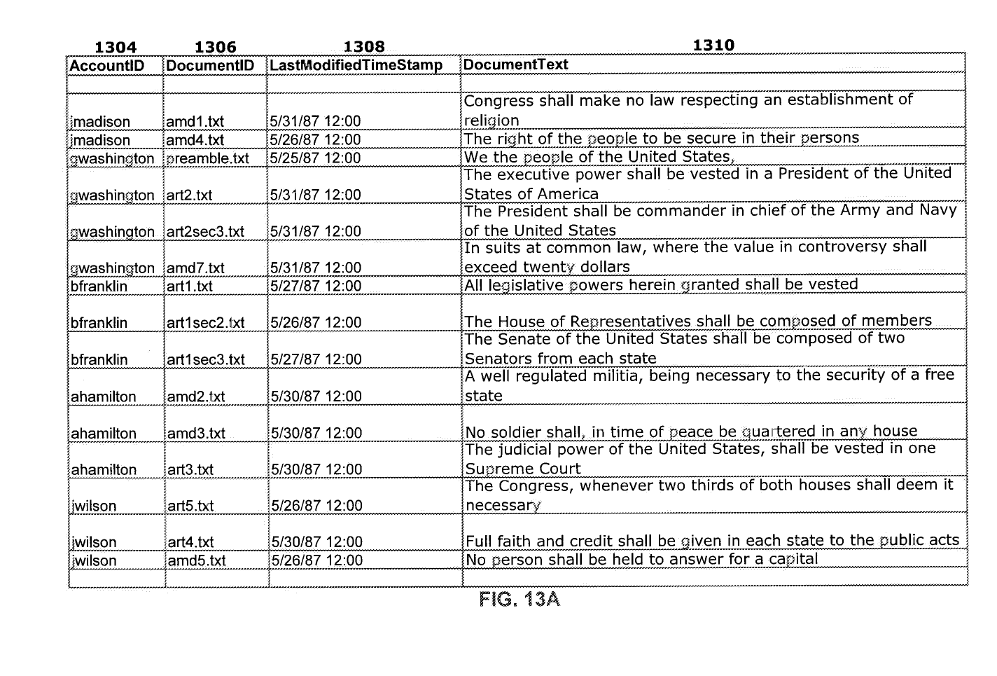

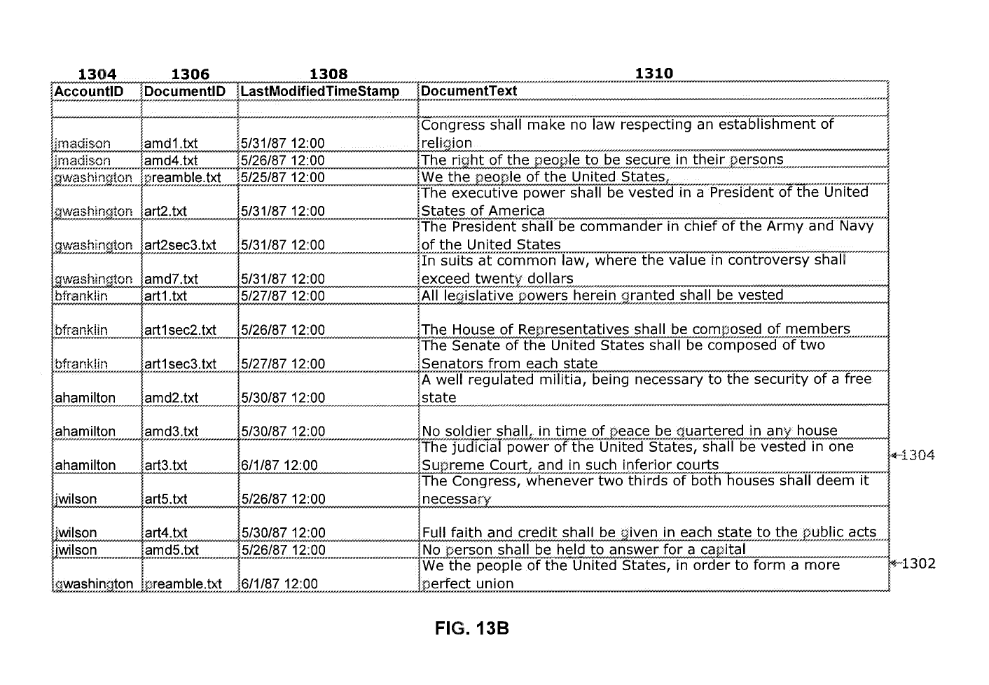

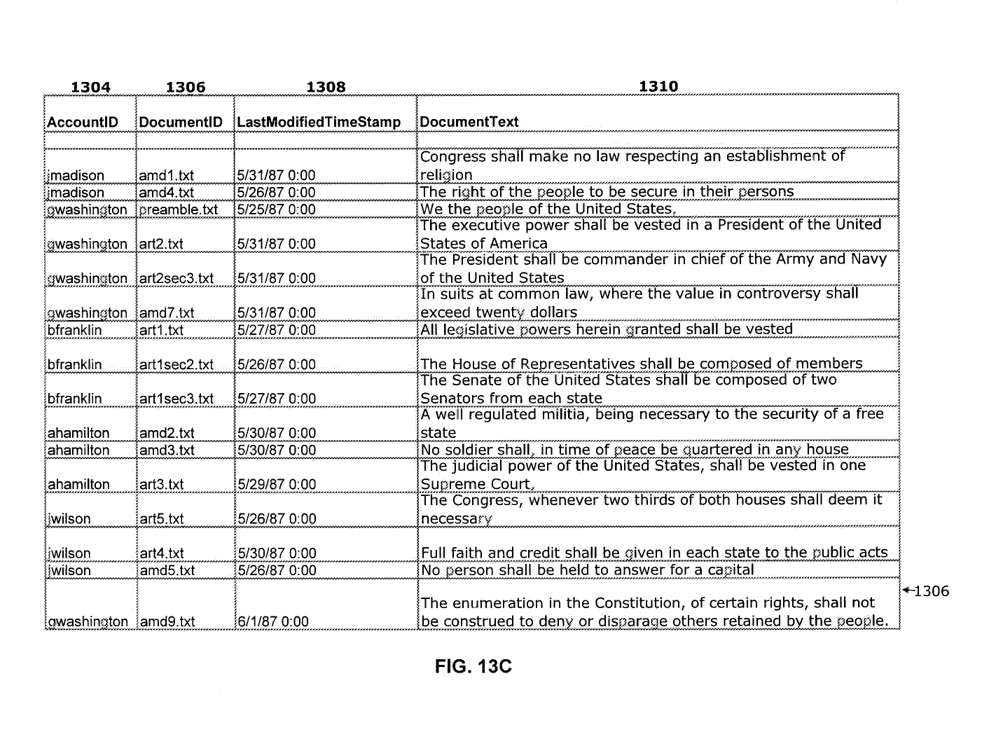

FIG. 13A shows an example database that may be used to store documents in accordance with FIG. 12. Table 1300 is a representation of a portion of an exemplary database storing a set of documents distributed across a plurality of client devices in a hosted user environment in accordance with block 1202 of FIG. 12. Table 1300 shows fifteen documents, but is merely an example; the database may contain one to many documents.

Table 1300 contains columns for fields denoted AccountID 1304, DocumentID 1306, LastModifiedTimeStamp 1308, and DocumentText 1310. The database schema may contain more fields or fewer fields than are shown in table 1300, depending on the implementation of the embodiments.

For one sample document, the AccountID holds a value of “gwashington”. DocumentID holds a value of “preamble.txt”, and the LastModifiedTimeStamp holds a value of May 25, 1787 12:00. The DocumentText field reads “We the people of the United States”.

For another sample document, the AccountID holds a value of “ahamilton”. DocumentID holds a value of “art3.txt”, and the “LastModifiedTimeStamp” holds a value of May 29, 1787 12:00. The DocumentText field reads “The judicial power of the United States . . . ”.

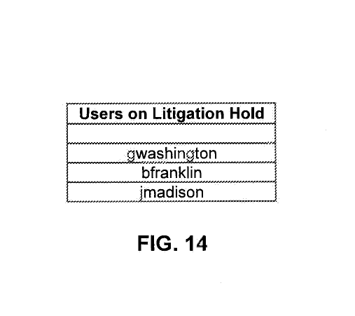

FIG. 14 is an exemplary list of a database or table storing criteria of documents on litigation hold. Such a database may store a list of users, or may contain other criteria indicative of documents on litigation hold. In this example, FIG. 14 lists three users that have been placed on litigation hold: accounts jmadison, gwashington, and jwilson.

As described with respect to block 1204, user gwashington may modify document preamble.txt on Jun. 1, 1787 and append a line of text to the document. The software used by user gwashington to modify document preamble.txt may send a notification to the central database of such a modification. In accordance with block 1206 of method 1200, it is determined whether document preamble.txt is subject to a litigation hold. In this example, because user account gwashington exists in the list of accounts subject to litigation hold shown in FIG. 14, and gwashington is the AccountID associated with the DocumentID preamble.txt, the document sample.txt is on litigation hold. This determination may also be done, for example and without limitation, by querying a database of documents subject to litigation hold, querying a list of users subject to litigation hold, by noting a characteristic of the document, or any other method known to those skilled in the art.

Because the document preamble.txt is known to be on litigation hold, the a copy of the modified preamble.txt may be inserted into the database of documents, in accordance with block 1210 of FIG. 12. The DocumentID and AccountID values may stay constant. In order to keep track of revisions to documents on litigation hold, the LastModifiedTimeStamp may be updated to reflect the actual time and date the document was modified. Additionally, the DocumentText field may be updated to identify the updated content of the document. An updated table including the modified preamble.txt is shown in FIG. 13B. The entry for the modified preamble.txt is shown in row 1302.

In accordance with block 1208 of method 1200, if a document is found not to be on litigation hold, the database entry may be overwritten. In this example, user ahamilton may modify document art3.txt and append a line of text to the document. Because user ahamilton does not exist in the list of accounts subject to litigation hold shown in FIG. 14, the document art3.txt is not on litigation hold. Thus, the row containing the original art3.txt document may be overwritten. The AccountID and DocumentID fields may remain with the same values, while the LastModifiedTimeStamp field may be updated with the current modified time and date. Further, the DocumentText field may be overwritten with the original text of the document plus the added text. FIG. 13B also displays the result of a modification to document art3.txt at row 1304.

In an embodiment, once a litigation hold period is over, the database of documents may be purged of old versions of documents if they are no longer necessary. For example, the purging operation may check the LastModifiedTimeStamp field, and delete all versions of documents except the most recently modified document. This may be done, for example, to save space and capacity on a company's network.

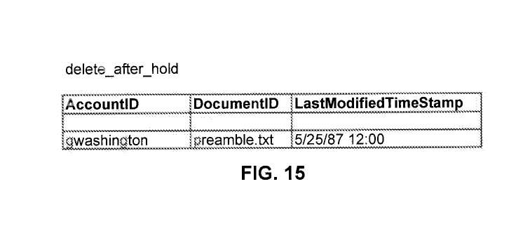

Alternatively, a second index or table may exist that keeps track of original documents and corresponding modified documents. At the termination of the litigation hold period, the index may be queried for documents that should be deleted. In an example of this embodiment, gwashington seeks to modify the preamble.txt document as detailed above. The copy of the original document is maintained in the database, and a copy of the modified document is added to the database of all documents. In addition, an entry is inserted into a second table, named “delete_after_hold” with the AccountID, DocumentID, and LastModifiedTimeStamp of the original document. At the expiration of the litigation hold period, the “delete_after_hold” table may be queried to determine the documents that may be deleted. Using an appropriate software tool, these documents may be deleted from the database of stored documents to save space. Such an exemplary table is shown in FIG. 15.

In an embodiment, the hosted user environment is periodically searched for new documents. The environment may be searched hourly, daily, weekly, or at any other time interval desired by the company. A search of the hosted user environment also may be triggered manually. If a new document is found to have been created between the last search of the hosted user environment and the current search, it is added to the database of current documents. If the user who created the document is under litigation hold or is later placed on litigation hold, that document's updates can then be tracked as well in accordance with embodiments to comply with legal obligations. FIG. 16 is a flowchart of an exemplary method 1600 in accordance with such an embodiment.

In block 1602 of FIG. 16, a new electronic document is created. The document may be a text document, spreadsheet, e-mail, presentation, or any other type of electronic document. At block 1604, a notification that a new document has been created is received. This notification may be triggered by the software used to create the document, by an individual user's file manager software, or by other monitoring software.

At block 1606, the database is updated with the newly created document. For example, a new row may be added to a table such as the example shown in FIG. 13A. The table may be updated with the AccountID of the document creator, the date the document was created, and the full text of the document.

Adding the document to the database allows it to be preserved under litigation hold if such a hold arises. For example, if future modification to the document occurs, a device implementing method 1600 will enable preservation of the original document should it be on litigation hold.

In an example in accordance with method 1600 of FIG. 16, on Jun. 1, 1787, user gwashington creates a new document, amd9.txt. User gwashington's file manager software may notify the central document database of the new document. In response, the central document database stores a copy of the new document amd9.txt, along with the identifying information and the document's full text. An updated index is shown in FIG. 13C with the updated document at row 1306. In the future, if user gwashington is placed on litigation hold, changes to the document amd9.txt will be tracked to comply with any litigation hold.

In an embodiment, a user may wish to delete a document. Using the example values detailed above, user jmadison may seek to delete document amd1.txt. In the example of FIG. 14, user jmadison is present on the litigation hold list. Thus, the document amd1.txt may need to be maintained in the database shown in Table 1300. However, the document amd1.txt may be removed from user jmadison's view, since the user requested deletion of the document. For example, the file manager software used by user jmadison may be notified to remove document amd1.txt from user jmadison's view. Keeping the document in the user's view will likely only serve to confuse and/or frustrate the user. The original version of the document may also be deleted from its previous location in the distributed system. However, a copy of the document will remain in the database so as to comply with the litigation hold. In a further example, if user ahamilton wishes to delete a document, he may be able to do so because he is not listed on the users on litigation hold.

In an embodiment, a document a user subject to litigation hold wished to delete is marked for deletion at the end of the litigation hold period. This may be done, for example, by extending the database schema shown in Table 1300 to contain another column that identifies that a particular document should be deleted at the expiration of the litigation hold period. For example, if the litigation hold period ends, documents that user jmadison wished to have deleted may be purged from the database.

In many business environments, documents may be shared and edited by multiple users. Users may be subject to litigation hold or not, depending on various criteria. In an embodiment, if a document is shared between more than one user, multiple copies may be retained in the database or central archive, in order to comply with the various litigation holds and preservation requirements that may be applicable to the document. Thus, multiple databases, central archives, or repositories may be utilized. For example, each user may have a corresponding litigation hold repository. Additionally, multiple copies of documents may be stored when retention policies for various users vary. For example, if two users in different companies collaborate on the same document, each user's company may have a different document retention policy. By storing multiple copies of the document, each copy of the document may be stored for a length of time according to the particular company's retention policy.

For example, user gwashington and jmadison may collaborate on a particular document. User gwashington may be subject to litigation hold, while jmadison may not be subject to litigation hold. Thus, a copy of the document may be stored in a repository for user gwashington and user jmadison. If user jmadison wishes to delete the document, it may be removed from his repository, because he is not on litigation hold. The document will remain in user gwashington's repository. Once user gwashington is no longer on litigation hold, the document may be deleted.

As a further example, user gwashington and jmadison may collaborate on a particular document, but be subject to separate retention policies. Copies corresponding to each of gwashington and jmadison may be stored in accordance with embodiments. If, for example, gwashington is removed as a collaborator from the document, the copy of the document corresponding to user gwashington may no longer be updated when the document is modified, and the copy may be stored only as long as the retention policy specifies.

FIG. 17 is an illustration of a litigation hold system 1700 that may be used to implement embodiments described herein. Litigation hold system 1700 includes a document locator 1702, a metadata updater 1704, a document index 1706, and update feed receiver 1708. Litigation hold system 1700 also includes central archive 1710.

Litigation hold system 1700 may execute method 500 identified in FIG. 5 and further explained above, but is not limited and may operate in accordance with other embodiments.

In the embodiment shown in FIG. 17, litigation hold system 1700 receives preservation criteria 1701. Preservation criteria may include, for example and without limitation, a list of user accounts, a document type, documents relating to a particular topic, documents containing particular content, documents containing particular keywords, or other criteria.

Document locator 1702 may query a hosted user environment utilizing a distributed file system to locate documents matching the preservation criteria. In such a hosted user environment, document locator 1702 may query the individual client devices in the hosted user environment to locate documents satisfying the preservation criteria. Document locator 1702 may send an indication to individual client devices causing the individual client devices to send documents satisfying the preservation criteria to litigation hold system 1700.

Metadata updater 1704 may update the metadata of documents located by document locator 1702 with an indication that the document is on litigation hold.

Litigation hold system 1700 also may maintain a document index 1706 created to keep an index of documents on litigation hold. Such an index may be similar to the index of FIG. 7B.

Litigation hold system 1700 may also include an update feed receiver 1708. Update feed receiver 1708 may periodically receive an update feed from client devices in the hosted user environment of updates, modifications, and creations of documents matching preservation criteria. Update feed receiver 1708 may work in concert with document locator 1702 to cause individual client devices to send updated documents satisfying preservation criteria to litigation hold system 1700. Update feed receiver 1708 may also periodically query the hosted user environment for newly created documents satisfying the preservation criteria, in accordance with an embodiment.

Litigation hold system 1700 may also include central archive 1710. Central archive 1710 may store documents matching preservation criteria, in accordance with embodiments described herein. In accordance with other embodiments, central archive 1710 may store a copy of the set of documents distributed across a distributed file system.

Litigation hold system 1700 described herein can be implemented in software, firmware, hardware, or any combination thereof. The litigation hold system can be implemented to run on any type of processing device including, but not limited to, a computer, workstation, distributed computing system, embedded system, stand-alone electronic device, networked device, mobile device, set-top box, television, or other type of processor or computer system.

Litigation hold system 1700 may be connected to a network in a hosted user environment utilizing a distributed file system, such as the network 403 described with respect to FIG. 4. In this way, litigation hold system 1700 may access the data stored on storage devices 405a-405d to implement embodiments described herein. Additionally, a user interface 1712 may be provided to litigation hold system 1700.

An advantage of embodiments is that a central archive may allow early case assessment to be performed quickly. For example, a member of a legal team may quickly and efficiently search all documents meeting certain preservation criteria or all documents in an organization to determine how many documents require review, and then properly allocate resources to that review. Additionally, because documents may be searched across various applications in an enterprise, security breaches may be identified quickly. For example, a security engineer may be able to quickly search user data to determine if a user has forwarded or shared a confidential document outside of the enterprise.

Embodiments may be implemented in hardware, software, firmware, or a combination thereof. Embodiments may be implemented via a set of programs running in parallel on multiple machines. In an embodiment, different stages of the described methods may be partitioned according to, for example, the number of documents on each storage machine, and distributed on the set of available machines.

The summary and abstract sections may set forth one or more but not all exemplary embodiments of the present invention as contemplated by the inventor(s), and thus, are not intended to limit the present invention and the appended claims in any way.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments.

What is claimed is:

1. A method of preserving documents under a litigation hold, comprising:
locating, by a processor, a set of documents corresponding to received preservation criterion across a plurality of client devices;
storing, by the processor, a copy of each document in the set of located documents into a repository;
receiving, by the processor, a notification of an alteration to a particular document in the set of located documents; and
storing, by the processor, the altered version of the particular document in the repository when the notification is received while maintaining a prior version of the particular document.

2. The method of claim 1, further comprising:
receiving a notification of a newly created document corresponding to the preservation criteria; and
storing a copy of the newly created document in the repository.

3. The method of claim 1, further comprising:
receiving one or more additional preservation criteria for a litigation hold;
locating a set of documents corresponding to the additional preservation criteria across a plurality of client devices; and
updating the repository by storing a copy of each document in the set of located documents.

4. The method of claim 1, further comprising:
receiving a notification of a modification of a particular document that, upon modification, satisfies the preservation criteria;
storing a copy of the document into the repository.

5. The method of claim 1, further comprising:
receiving exploratory preservation criteria for a litigation hold;
locating a set of documents corresponding to the exploratory preservation criteria across a plurality of client devices; and
finalizing the preservation criteria based on the exploratory preservation criteria.

6. The method of claim 1, further comprising exporting the repository of documents for review.

7. A method of preserving documents under a litigation hold, comprising:
for a set of documents distributed across a plurality of client devices, storing a copy of each original document in the set of documents into a database;
receiving, by a processor, a notification from a client device that an original document in the set of documents has been altered;
determining, by the processor, whether the original document is subject to a litigation hold;
overwriting, by the processor, the copy of the original document stored in the database with the altered document when the original document is not subject to a litigation hold; and
storing, by the processor, a copy of the altered document in the database when the original document is subject to a litigation hold while maintaining the original version of the document.

8. The method of claim 7, further comprising:
maintaining an index of stored copies of altered documents and corresponding original documents.

9. The method of claim 8, further comprising:
purging the original document upon termination of the litigation hold when an altered document corresponding to the original document exists.

10. The method of claim 7, further comprising:
receiving a notification from a client device of a newly created document; and
storing a copy of the newly created document in the database.

11. The method of claim 7, further comprising:
receiving a notification from a client device that an original document in the set of documents is to be deleted;
determining whether the original document is subject to a litigation hold;
deleting the original document stored in the database when the original document is not subject to a litigation hold;
maintaining a copy of the original document in the database when the particular original document is subject to a litigation hold; and
marking the original document for deletion after termination of the litigation hold.

12. A litigation hold system for preserving documents under a litigation hold in a hosted user environment, comprising:
a preservation criteria receiver that receives criteria of documents to be placed on litigation hold;
a document locator that queries a hosted user environment and locates documents corresponding to received preservation criteria;
an archive that stores documents located by the document locator; and
an update feed receiver that receives updates from one or more client devices in the hosted user environment of newly-created or additional documents satisfying preservation criteria.

13. The litigation hold system of claim 12, further comprising a document index that maintains an index of documents matching preservation criteria.

14. The litigation hold system of claim 12, further comprising a metadata updater that modifies the metadata of documents matching preservation criteria to indicate that the documents are on litigation hold.

15. The litigation hold system of claim 12, further comprising:
an exploratory preservation criteria receiver that receives exploratory preservation criteria; and
a preservation criteria finalizer that creates preservation criteria of documents to be placed on litigation hold.

16. The litigation hold system of claim 12, further comprising a preservation module that is configured to preserve original documents on litigation hold when they are deleted from the hosted user environment.

17. The litigation hold system of claim 16, wherein the preservation module is further configured to preserve original versions of documents on litigation hold when the original versions are modified in the hosted user environment.

18. The litigation hold system of claim 17, wherein the preservation module is further configured to delete the original versions of modified documents at the close of the litigation hold period.

19. The litigation hold system of claim 16, wherein the preservation module is further configured to delete the original document at the close of the litigation hold period.

20. A computer readable storage medium having a plurality of instructions stored thereon that, when executed by one or more processors, cause the one or more processors to execute a method of preserving documents under a litigation hold, the method comprising:
locating a set of documents corresponding to received preservation criterion across a plurality of client devices;
storing a copy of each document in the set of located documents into a repository;
dynamically receiving a notification of an alteration to a particular document in the set of located documents; and
storing the altered version of the particular document in the repository when the notification is received while maintaining a prior version of the particular document.
